(19) United States
(12) Patent Application Publication
(10) Pub. No.: US 2004/0154651 A1
(43) Pub. Date: Aug. 12, 2004

(54) Processing liquid tank and processing system

(76) Inventor: Shori Mokuo, Tosu-Shi (JP)

Correspondence Address: SMITH, GAMBRELL & RUSSELL, LLP, 1850 M STREET, N.W., SUITE 800, WASHINGTON, DC, 20036, US

(21) Appl. No.: 10/645,570

(22) Filed: Aug. 22, 2003

(30) Foreign Application Priority Data
Aug. 23, 2002 (JP) 2002-243049

(51) Int. Cl. B08B 3/02

(52) U.S. Cl. 134/94.1; 134/95.1; 134/95.3; 134/102.1; 134/103.2; 134/200; 134/902

(57) ABSTRACT

The present invention provides a processing liquid tank and a processing system which take smaller spaces for the tank and the heat exchanger and can be realized at low costs. The processing liquid tank 100 for storing a prescribed processing liquid comprises an inner cylinder 130 in the processing liquid tank 100. The processing liquid is stored outer of the inner cylinder 130. The pipes 160a, 160b, 160c for passing a heat medium are disposed in the processing liquid. The flow of the heat medium passing through the pipes 160a, 160b, 160c is opposite to the flow of the heat medium. The processing device comprises a processing liquid tank 100, a processing unit for processing objects-to-be-processed and a processing liquid supply line for supplying a processing liquid from the process liquid tank to the processing unit.

### CROSS REFERENCE TO RELATED APPLICATIONS

The present application is related to subject matter disclosed in Japanese Patent Application No. 2002-243049 filed on Aug. 23, 2002 in Japan to which the subject application claims priority under Paris Convention and which is incorporated herein by reference.

### BACKGROUND OF THE INVENTION

1. Field of the Invention

The present invention relates to a processing liquid tank for storing a processing liquid, e.g., a cleaning liquid or others, and a processing system which feeds the processing liquid stored in the processing liquid tank and performs cleaning processing on objects-to-be-processed with the processing liquid.

2. Related Background Art

In the processes for fabricating, e.g., semiconductor devices, substrate processing systems which feed processing liquids heated to prescribed temperatures to process semiconductor wafers (hereinafter called “wafers”) with the processing liquids are used. One constitution for adjusting the temperature of such processing liquid has, for example, a heat exchanger inserted in a line which supplies a processing liquid from a tank to wafers. Another constitution for such use, for example, stores a processing liquid in a tank, and the processing liquid in the tank is heated by a heater disposed on the outer surface of the tank, and in this case, the tank is formed of a metal, such as SUS steel or others, so as to efficiently conduct the heat of the heater to the processing liquid.

However, in the conventional processing liquid tanks and the conventional processing systems, the heat exchanger takes a large space when inserted in the supply line. This has been a problem. Furthermore, when a processing liquid in the supply line is replaced by the fresh processing liquid, the processing liquid remaining inside the tank is drained, and the processing liquid remaining in the heat exchanger is also drained. The amount of the drained liquid is uneconomically large.

When an acid or an alkaline chemical liquid is heated by the heater provided on the outer surface or the tank, the chemical liquid corrodes a metal forming the tank, such as SUS steel or others, causing metal contamination, which contaminates wafers. This has been also a problem. To prevent this, the liquid contacting surface of the inside of the tank must be surface-treated with, e.g., electropolishing or others, which suppresses the elution of the metal. This will add to costs.

### SUMMARY OF THE INVENTION

Thus, an object of the present invention is to provide a processing liquid tank and a processing system which require small spaces for the tank and the heat exchanger and can realize low costs.

To solve the above-described problem, the present invention provides a processing liquid tank for storing a processing liquid comprising an inner cylinder disposed in the processing tank; the processing liquid being stored outside of the inner cylinder, a pipe for flowing a heat medium disposed in the processing liquid Such processing liquid tank takes smaller spaces in comparison with the processing liquid tank having the heat exchanger inserted in the supply line. In such processing liquid tank, when a processing liquid in the supply line is replaced with the fresh processing liquid, the amount of the drained liquid is smaller in comparison with the processing system in which the processing liquid remaining in the tank and heat exchanger is wasted, whereby the cost of the processing liquid can be low. The heat medium is water, silicone oil or others.

It is preferable that the processing liquid tank described above comprises a cylindrical straightening vane, defining a flow passage in which the processing liquid descends along the inside of the cylindrical straightening vane, passes between a lower part of the straightening vane and the bottom surface of the processing liquid tank and then ascends along the outside of the straightening vane, or a flow passage in which the processing liquid descends along the outside of the straightening vane, passes between a lower part of the straightening vane and the bottom surface of the processing liquid tank and ascends along the inside of the straightening vane, the pipe being arranged in the flow passage.

It is preferable that the flow of the heat medium passing through the pipe and the flow of the processing liquid are opposite to each other. The heat of the heat medium can be efficiently conducted to the processing liquid.

It is possible that the processing liquid tank comprises a baffleplate for partitioning the interior of the processing tank in an upper part and a lower part, the baffleplate being positioned upper of the pipe and the straightening vane; and an outlet pipe for drawing the processing liquid below the baffleplate out of a region inner or outer of the straightening vane without mixing the processing liquid below the baffleplate with the processing liquid upper of the baffleplate. It is preferable that the baffleplate is fixed to the inner cylinder or to the inside wall of the processing liquid tank, and the straightening vane is fixed to the baffleplate. It is possible that the baffleplate is tilted, and the outlet pipe is disposed in the higher part of the baffleplate.

It is preferable that the pipe is formed helically in the region outer of the straightening vane. It is possible that the pipe is formed helically in the region inner of the straightening vane. It is possible that the pipe is formed helically in the region outer of the straightening vane and in the region inner of the straightening vine.

It is preferable that the pipes are arranged substantially in parallel with each other. It is preferable that a plurality of the pipes are provided, and the pipes are juxtaposed with each other with their transverse sections arranged in a vertical line and formed helically in the region outer of the straightening vane. It is preferable that a plurality of the pipes are provided, and the pipes are juxtaposed with each other with their transverse sections arranged in a horizontal line and formed helically in the region inner of the straightening vane. It is preferable that a plurality of the pipes are provided, and the pipes are juxtaposed with each other with their transverse sections arranged in a vertical line and formed helically in the region outer of the straightening vane and are juxtaposed with each other with their transverse sections arranged in a horizontal line and formed helically in the region inner of the straightening vane.

It is possible that at least one of said plural pipes can be changed over to admitting a cooling heat medium and to admitting a heating heat medium. In addition to the state for heating the processing liquid, the state for adjusting the temperature of the processing liquid substantially to the room temperature and the state for cooling the processing liquid can be changed over.

It is preferable that the liquid contact surfaces of the processing liquid tank and the pipe are respectively made of a chemical liquid resistant resin. Accordingly, there is no risk of causing metal contamination. No surface treatment for suppressing the elution of metals is required, which can lower the cost. The pipe of, e g., fluororesin, whose radius curvature is restricted, is formed helically, whereby a surface area required for the temperature adjustment of the processing liquid can be formed.

It is possible that the inner cylinder has the bottom closed capably of storing a liquid inside. It is possible that the liquid in the inner cylinder has the temperature adjusted by the heat medium or the processing liquid. For example, not used, fresh processing liquid is stored in the inner cylinder, and the fresh processing liquid has the temperature adjusted substantially to a temperature of the processing liquid outside the inner cylinder by conducting the temperature of the processing liquid outside the inner cylinder to the fresh processing liquid, whereby when the fresh processing liquid is supplied, the processing liquid can be adjusted quickly to the prescribed temperature.

The present invention provides a processing system comprising the above-described processing liquid tank, a processing unit for processing objects-to-be-processed, and a processing liquid supply line for supplying a processing liquid from the processing liquid tank to the processing unit.

### BRIEF DESCRIPTION OF THE DRAWINGS

FIG. 1 is a sectional view of the substrate processing system with the inner chamber advanced in the outer chamber.

FIG. 2 is a sectional view of the substrate processing system with the inner chamber withdrawn out of the outer chamber.

FIG. 3 is a circuit diagram of the processing liquid circulatory supply circuit, which show a structure thereof.

FIG. 4 is a vertical sectional view of the processing liquid tank.

FIG. 5 is a sectional view of the processing liquid tank, which shows the structure thereof.

FIG. 6 is a sectional view of the processing liquid tank shown in FIG. 5 along the line A-A line.

FIG. 7 is a sectional view of the processing liquid tank shown in FIG. 5 along the line B-B line.

FIG. 8 is a sectional view of the processing liquid tank shown in FIG. 5 along the line C-C line.

FIG. 9 is a vertical sectional view of the processing liquid tank according to another embodiment.

FIG. 10 is an explanatory view of the circuit for circulating a heat medium in the piping according to said another embodiment.

FIG. 11 is a vertical sectional view of the processing liquid tank according to said another embodiment.

### DESCRIPTION OF THE PREFERRED EMBODIMENTS

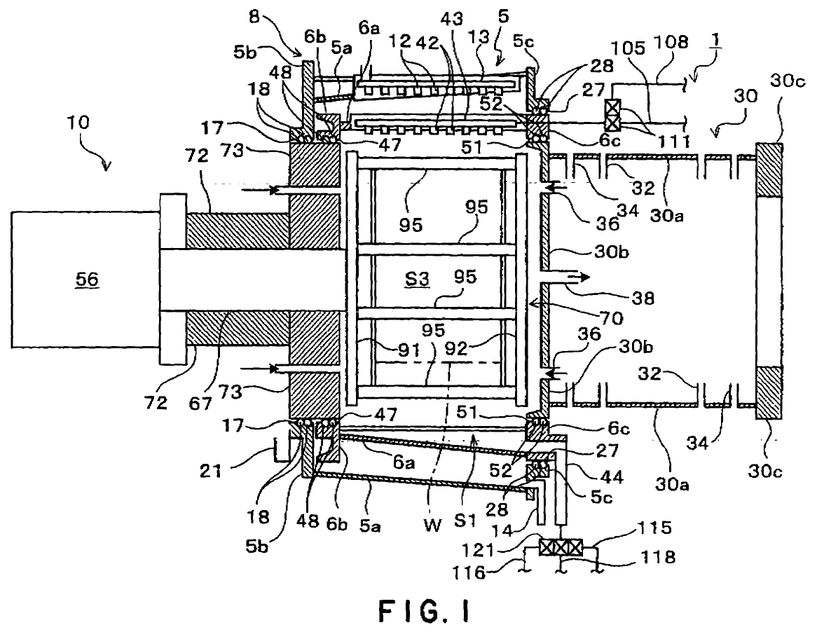

Preferred embodiments of the present invention will be described by means of a substrate processing system for cleaning wafers as objects-to-be-processed. As shown in FIG. 1, a substrate processing system 1 comprises a double chamber 8 including a stationary outer chamber 5, and an inner chamber 6 which is movable horizontally into and out of the outer chamber 5. The substrate processing system 1 further comprises a rotor rotating mechanism 10 which holds a plurality of wafers W, e.g., 25 wafers in parallel with each other, spaced from each other at a certain pitch. The rotor rotating mechanism 10 is movable horizontally into and out of the double chamber 5.

The outer chamber 5 comprises a cylindrical body 5a supported at a prescribed position by a frame not shown, and a ring 5b and a ring 5c fixed respectively to the end surfaces of the cylindrical body 5a A processing fluid injection nozzle, 13 having a number of processing liquid injection ports 12 formed horizontally therein is disposed above the cylindrical body 5a. A discharge pipe 14 which drains of a processing liquid and exhausts the interior of the outer chamber 5 is disposed below the cylindrical body 5a.

A rotor rotating mechanism entry/exit opening 17 through which the rotor rotating mechanism 10 goes into/out of the double chamber 8 is formed in the ring 5b. The rotor rotating mechanism entry/exit opening 17 can be opened/closed by a cap not shown when the rotor rotating mechanism 10 is out of the double chamber. An annular seal mechanism 16 is disposed on the inside circumferential surface of the rotor rotating mechanism entry/exit opening 17. On the outside of the ring 5b, a liquid trap 21 is disposed at a position below the rotor rotating mechanism entry/exit opening 17 so that the liquid trap 21 captures the processing liquid staying on the seal mechanism 18, etc. when the rotor rotating mechanism 10 is withdrawn out or the double chamber 8 after wafers W have been processed.

An inner chamber entry/exit opening 27 through which the inner chamber 6 goes into/out of the outer chamber 5 is formed in the ring 5c. An annular seal mechanism 28 is disposed on the inside circumferential, surface of the inner chamber entry/exit opening 27. A cleaning mechanism 30 for cleaning the inner chamber 6 is disposed on the outside of the ring 5c. The inner chamber 6 surrounds the cleaning mechanism 30 when withdrawn out of the outer chamber 5.

The cleaning mechanism 30 comprises a cylindrical chamber 30a to be surrounded by the inner chamber 6 which has been withdrawn out of the outer charter 5, a disc 30b formed on the end surface of the cylindrical body 30a which is nearer the ring 5c, surrounded by the inside circumferential surface of the inner chamber entry/exit opening 27, and a ring 30c formed on the other end surface of the Cylindrical body 30a. In the cylindrical body 30a there are formed gas ejection nozzle 32 for ejecting gas toward the outer periphery of the cylindrical body 30a, i.e., toward the inside periphery of the inner chamber 6 surrounding the cylindrical body 30a, and exhaust pipes 34 for discharging an atmosphere from the space between the inner periphery of the inner chamber 6 surrounding the cylindrical body 30a and the outer periphery of the cylindrical body 30a. In the disc 30b there are provided cleaning liquid injection nozzles 36 for injecting a cleaning liquid and a gas into the outer chamber 5, and an exhaust pipe 39 for discharging an atmosphere in the outer chamber. The thus structured cleaning mechanism 30 cleans with the gas supplied from the gas injection nozzles 32 the inside circumferential surface of the inner chamber 6 which has been moved to the withdrawn position.

The inner chamber 6 comprises a cylindrical body 6a which is formed in a size which allows the inner chamber 6 to be moved from the center of the ring 5c into the cylindrical body Ba and surround the outer periphery of the rotor rotating mechanism 10 and further the outer periphery of the cylindrical body 30a, and rings 6b, 6c respectively fixed to the end surfaces of the cylindrical body 6a. A processing fluid injection nozzle 43 having a number of processing liquid injection ports 42 formed horizontally is disposed above the cylindrical body 6a. The processing fluid injection nozzle 43 supplies a chemical liquid and IPA. Below the cylindrical body 6a there is disposed a drain pipe 44 for discharging the processing liquid and the gas from the inner chamber 6.

In the ring, 6b there is formed a rotor rotating mechanism entry/exit opening 47 through which, in the outer chamber 5, the rotor rotating mechanism 10 is advanced or withdrawn relatively in and out of the inner chamber 6. An annular seal mechanism 48 is provided on the inside circumferential surface of the rotor rotating mechanism entry/exit opening 47. In the ring 6c there is formed a passage opening 51 in a size which relatively admits in the cleaning mechanism 30. An annular seal mechanism 52 is provided on the inside circumferential surface of the ring 6c.

The rotor rotating mechanism 10 comprises a motor 66, a rotary shaft 67 for the motor 56, and a rotor mounted on the forward end of the rotary shaft 67 for holding 25 wafers W in parallel with each other, spaced at a certain pitch. The motor S6 is supported by a casing 72 surrounding the rotary shaft 57. The casing 72 is supported by a moving support mechanism not shown. The moving support mechanism moves the rotor rotating mechanism 10 as a whole horizontally to advance or withdrawn the rotor 70 into/out of the double chamber 8. Between the casing 72 and the rotor 70 and on the forward end of the casing 72 there is disposed a disc cap 73 in a size which closes the rotor rotating mechanism entry/exit openings 17, 47 when the rotor 70 is advanced into the double chamber 6.

As shown in FIG. 1, when the inner chamber 6 is located at the processing position in the outer chamber 5, and the rotor 70 is positioned in the inner chamber 6, the ring 6c provides the closure between the inner chamber entry/exit opening 27 and the disc 30b, the seal mechanism 28 seals between the ring 5c and the ring 6c, and the seal mechanism 52 seals between the ring 6c and the disc 30b. The cap 73 closes the rotor rotating mechanism entry/exit openings 17, 47, and the seal mechanism 18 seals between the ring 5b and cap 73. The seal mechanism 48 seals between the ring 6b and the cap 73. The disc 30b, the ring 6c, the cylindrical body 6a, the ring 6b, and the cap 73 thus define a processing space S1.

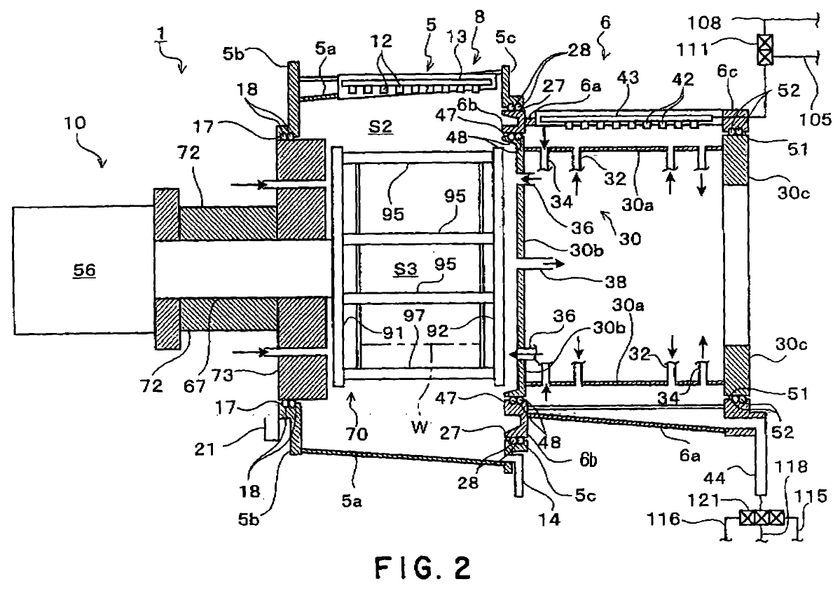

As shown in FIG. 2, when the inner chamber 6 is withdrawn out of the outer chamber 5 to be located at the withdrawn position, and the rotor 70 is positioned inside the outer chamber 5, the ring 6b provides the closure between the inner chamber entry/exit opening 27 and the disc 30b, the seal mechanism 28 seals between the ring 5c and the ring 6b, and the seal mechanism 48 seals the ring 6b and the disc 30b. The cap 73 closes the rotor rotating mechanism entry/exit opening 17, and the seal mechanism 18 seals between the ring 5b and the cap 73. The disc 30b, the ring 6b, the ring 5c, the cylindrical body 5a, the ring 5b and the cap 73 define a processing space S2.

The rotor 70 comprises a pair of discs 91, 92 arranged at a prescribed interval which admits 25 wafers W. The disc 91 is mounted on the forward end of the rotary shaft 67, and the disc 92 is disposed nearer the ring 5c. Six (6) holding rods 95 which cooperate to hold the peripheral edges of 25 wafers W inserted between the discs 91, 92 are arranged circumferentially to the rotary shaft 67, respectively horizontally and in parallel with each other. The space defined by the 6 holding rods 9 is a wafer W holding space S3. Each of the 6 holding rods 95 has 25 grooves for the peripheral edges of wafers W to be engaged in. Twenty-five (25) wafers W are held with the peripheral edges engaged in the grooves of the 6 holding rods, whereby the 25 wafers W mounted on the rotor 70 are held in parallel with each other.

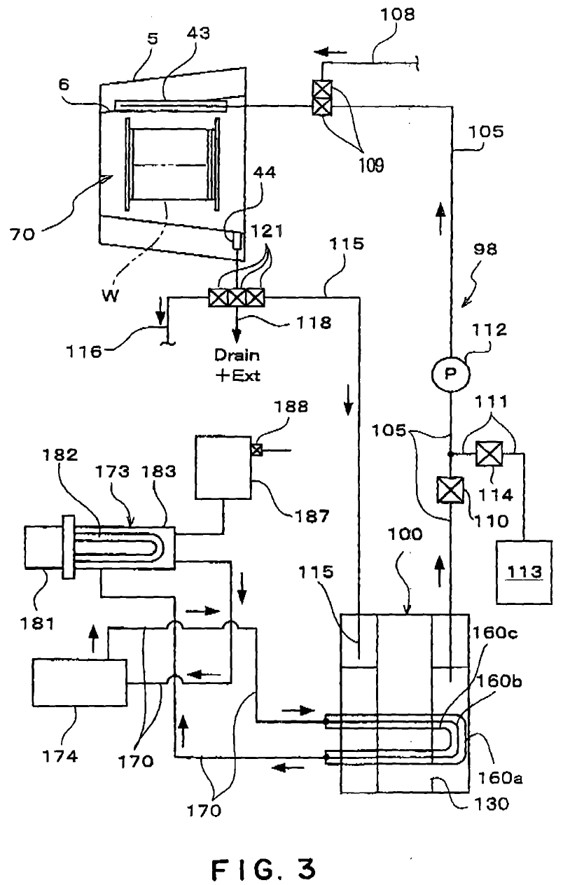

FIG. 3 diagrammatically shows the chemical circulatory supply circuit 98 of the substrate processing system 1. The processing fluid injection nozzle 43 provided in the above-described inner chamber 6 is connected via a change-over opening/closing valve 109 to a chemical liquid supply line 105 which supplies a chemical liquid stored in a chemical liquid tank 100 to wafers W in the double chamber 8, and an IPA supply line 108 which supplies IPA (isopropyl alcohol) from an IPA tank not shown to the wafers W in the double chamber 8. The change over opening/closing valve 109 is changed over between the chemical liquid supplying state and the IPA supplying state.

An opening/closing valve 110, a fresh chemical liquid supply line 111, a pump 112 are inserted in the chemical liquid supply line 105 in the stated order from the chemical liquid tank 100. The fresh chemical liquid supply line 111 is connected to a fresh chemical liquid tank 113 for storing a fresh chemical liquid and has an opening/closing valve 114 inserted in which the change-over between the state that the fresh chemical liquid is supplied from the fresh chemical liquid tank 113 and the state that the supply is stopped. Temperature adjusting means not shown for adjusting a fresh chemical liquid to a prescribed temperature is provided in the fresh chemical liquid tank 113. When the opening/closing valve 110 is opened, and the opening/closing valve 114 is closed, a chemical liquid stored in the chemical liquid tank 100 is admitted to the chemical liquid supply line 105 and can be red to the wafers W in the double chamber 8. When the opening/closing valve 110 is closed, and the opening/closing valve 114 is opened, the fresh chemical liquid stored in the fresh chemical liquid tank 113 is admitted sequentially to the fresh chemical liquid supply line 111 and the chemical liquid supply line 105 and can be fed to the wafers W in the double chamber 8.

The drain pipe 44 provided in the inner chamber 6 is connected via a change-over opening/closing valve 121 to a chemical liquid recovery line 115 connected to the chemical liquid tank 100, an IPA recovery line 116 and a drain line 118 which does not recover the drained chemical liquid but drains the same. The change-over opening/closing valve 121 is changed over among the state that the chemical liquid is recovered, the state that the IPA is recovered, and the state that the chemical liquid is drained.

By the operation of the pump 112, a chemical liquid is delivered from the chemical liquid tank 100 to the processing fluid injection nozzle 43 through the chemical liquid supply line 105 and fed to the wafers W in the inner chamber 6 through the processing liquid injection ports 42. The chemical liquid which has been fed to the wafers W is drained out of the inner chamber 6 through the drain pipe 44, and then delivered to the chemical recovery line 115 or is not recovered but drained through the drain line 118. The chemical liquid delivered to the chemical liquid recovery line 115 is again stored in the chemical liquid tank 100. The chemical liquid recovered is delivered through the chemical liquid supply line 105 to be fed to the waters W. The chemical liquid recovery line 115, the chemical liquid tank 100, and the chemical liquid supply line 105 thus constitute the chemical liquid circulatory supply circuit 98. When fresh chemical liquid is supplied, the opening/closing valve 110 is closed, and the opening/closing valve 114 is opened to deliver the not used chemical liquid from the fresh chemical liquid supply line 111 to the chemical liquid supply line 105.

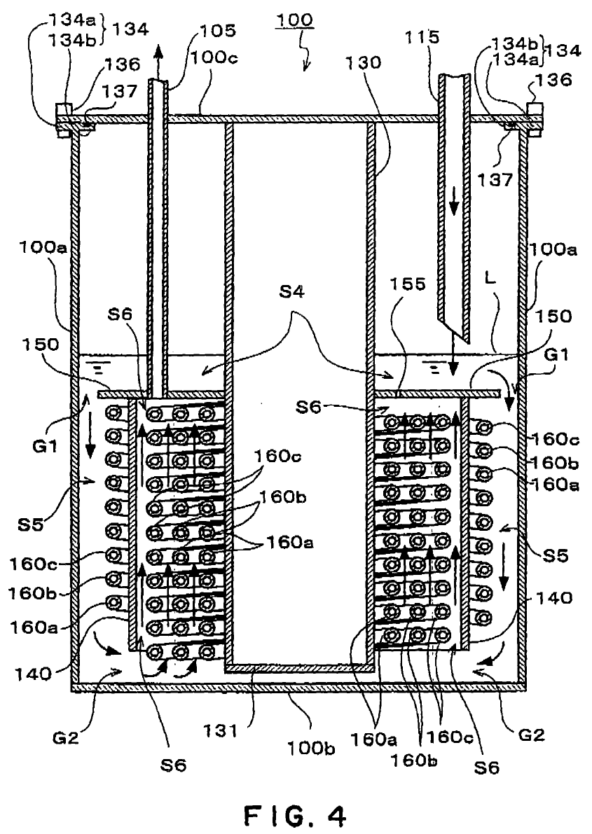

FIG. 4 is a vertical sectional view of the chemical liquid tank 100. The chemical liquid tank 100 comprises a cylindrical wall 100a, a bottom surface 100b and a cap 100c. An inner cylinder 130 is disposed in the cylindrical wall 100a near the center. The radius of the inner cylinder 130 is about 1/2 of the radius of the cylindrical wall 100a. The radius of the inner cylinder 130 can be about 1/4-3/4 of the radius of the cylindrical wall 100a. The inner cylinder 130 has the bottom closed by a bottom surface 131 near the bottom surface 100b of the body of the chemical liquid tank 100 and has a cylindrical void inside. The chemical liquid is stored outside the inner cylinder 130 and the bottom surface 131, i.e., outside the void. The inner cylinder 130 has the upper end jointed to the underside of the cap 100c.

A flange 134 is formed on the upper end of the cylindrical wall 100a. The upper surface of the flange 134 is brought into contact with the underside of the cap 100c. The flange 134 comprises a flange portion 134a formed outside the cylindrical wall 100a, and a flange portion 134a formed inside the cylindrical wall 100a. Bolt holes are formed in the flange portion 134a and the cap 100c. An annular groove in which a seal 137 is to be engaged in is formed in the upper surface of the flange portion 134b. The cap 100c is fixed to the cylindrical wall 100a with fastening members 136 in the form of bolts to be inserted in the bolt holes formed in the flange portion 134a and nuts. In this case, the seal member 137 is tightly contacted to the underside of the cap 100c to thereby seal between the upper surface of the flange 134 and the underside of the cap 100c. Positioning the seal member 137 inside the cylindrical wall 100a allows the outer diameters of the flange 134 and the cap 100c to be small. Accordingly, the outer diameter of the chemical liquid tank 100 can be small.

As shown in FIGS. 3 and 4, a cylindrical straightening vane 140 for forming a flow passage of the chemical liquid is provided around the inner cylinder 130. A baffleplate 150 for partitioning the interior of the chemical liquid tank 100 in the upper part and the lower part is jointed to the outer circumferential surface of the inner cylinder 130. A gap G1 is defined along the inside circumferential surface of the inner cylinder 100a between the outer circumferential edge of the baffleplate 150 and the inside circumferential surface of the inner cylindrical wall 100a.

The straightening vane 140 is positioned below the baffleplate 150 with the upper end jointed to the underside of the baffleplate 150. A gap G2 is defined between the lower end of the straightening vane 140 and the bottom surface 100b of the chemical liquid tank 100. The straightening vane 140 is formed inner of the outer circumferential edge of the baffleplate 150. That is, the region S4 upper of the baffleplate 150 and the region S5 outer of the straightening vane 140 are communicated with each other through the gap G1, and the region S5 outer of the straightening vane 140 and the region S6 inner of the straightening vane 140 shown in FIG. 4 are in communication with each other through the gap G2. The region S6 inner of the straightening vane 140 is closed at the top by the baffleplate 150.

The chemical liquid tank 100, the straightening vane 140 and the baffleplate, 150 are made of PER (tetrafluoroethylene perfluoroalkylvinylether copolymer). In this case, the liquid contacting surfaces, which contact chemical liquids, have chemical liquid resistance, and there is no risk of metal contamination of the wafers W. Making them of PFA can lower the costs in comparison with making them of a metal, such as SUS steel or others and further making a surface treatment for suppressing the elution of the metal.

The chemical liquid recovery line (inlet pipe) 115 described above is passed through the cap 100c, and introduces used chemical liquid into the chemical liquid tank 100 and injects the used chemical liquid into the region S4 upper of the baffleplate 150. The chemical supply line (outlet pipe) 105 described above is passed through the cap 100c and the baffleplate 150 and is opened in the underside of the baffleplate 150 to draw the chemical liquid near the underside of the baffleplate 150 out of the region S6 inner of the straightening plate 140. Because the region S4 upper of the baffleplate 150 and the region S6 inner of the straightening plate 140 are separated by the baffleplate 150, the chemical liquid supply line(outlet pipe) 105 can lead out the chemical liquid below the baffleplate 150 without mixed with the chemical liquid upper of the baffleplate 150.

When a chemical liquid is stored up to a height (liquid surface height L) near the downstream end (entrance of the chemical liquid) of the chemical liquid recovery line (inlet pipe) 115, the baffleplate 150 and the straightening vane 140 are immersed in the chemical liquid. Because the region S4 upper of the baffleplate 150 and the region S6 inner of the straightening vane 140 are separated by the baffleplate 150, the chemical liquid in the region S4 and the chemical liquid in the region S6 do not mix with each other. An air vent 155 is passed through the baffleplate 150 from the upper surface to the underside, so that when a chemical liquid is stored up to a position higher than the baffleplate 150, no gas stagnates upper in the region S6. The downstream end of the chemical liquid recovery line (inlet pipe) 115 is positioned upper of the chemical liquid surface.

As shown in FIGS. 4 and 5, 3 pipes 160a, 160b, 160c for flowing a heating medium are disposed in a chemical liquid stored in the chemical liquid tank 100. The pipes 160a, 160b, 160c are made of PFA, which has chemical liquid resistance and has annular section. The heat medium is water, silicone oil or others.

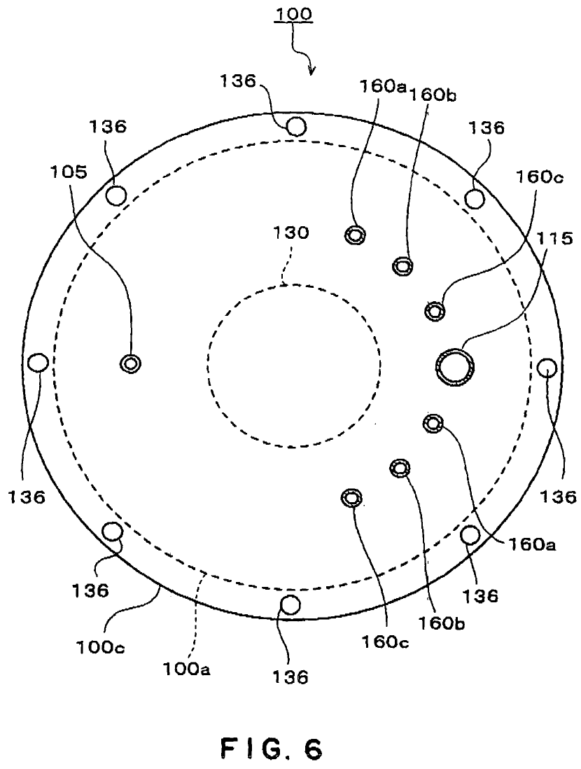

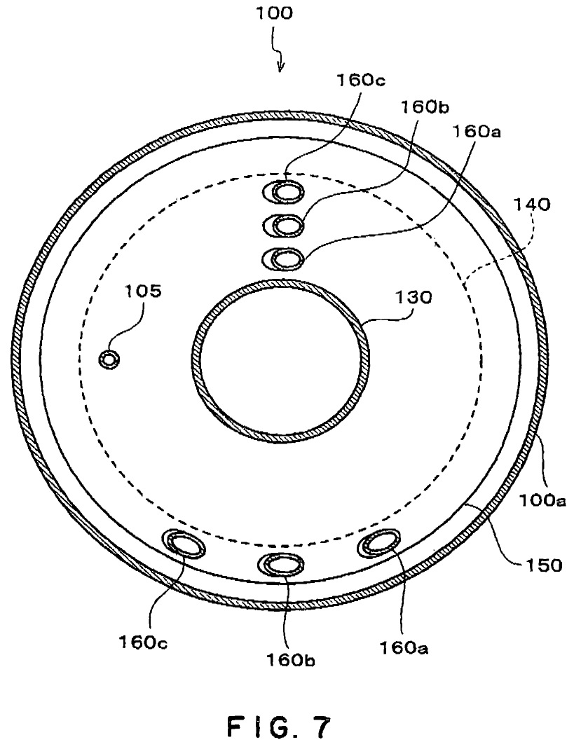

As shown in FIG. 6, the three pipes 160a, 160b, 160c are respectively passed through the cap 100c of the chemical liquid tank 100 and, as shown in FIG. 7, are passed respectively through parts of the baffleplate 150 which are inner of the straightening vane 140 to be inserted in the region S6.

Below the baffleplate 150, the 3 pipes 160a, 160b, 160c are juxtaposed substantially in parallel with each other in the stated order and are spaced from each other substantially at a certain interval. The 3 pipes 160a, 160b, 160c are arranged helically along the inner cylinder 130 and the straightening vane 140 from a position near the underside of the baffleplate 150 to the lower end of the straightening vane 140. That is, in the region S6 inner of the straightening vane 140, the 3 pipes 160a, 160b, 160c are formed helical away from the center of chemical liquid tank 100, juxtaposed with each other in the stated order. Innermost with respect to the outside circumferential surface of the inner cylinder 130, the pipe 160a is formed helically around the outside circumferential surface of the inner cylinder 130, spaced from each other at a substantially certain interval. Outer of the pipe 160a, the pipe 160b is formed helically, spaced from the pipe 160a at a substantially set interval. Outer of the pipe 160b, the pipe 160c is formed helically, spaced from the pipe 160b at a substantially set interval. Thus, as shown in FIG. 4, in the region S6, the helix of the pipe 160a, the helix of the pipe 160b and the helix of the pipe 160 are stacked in the stated order from the inside, forming triple helixes.

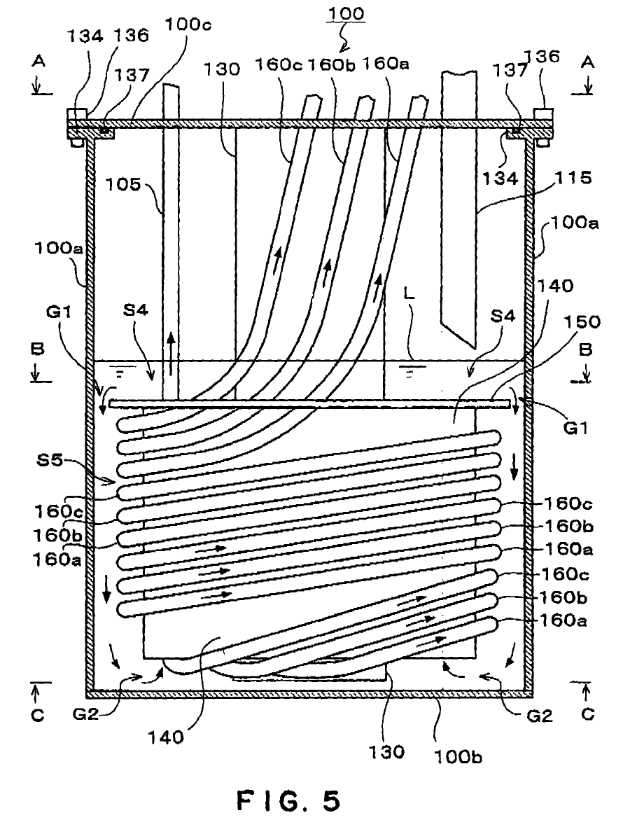

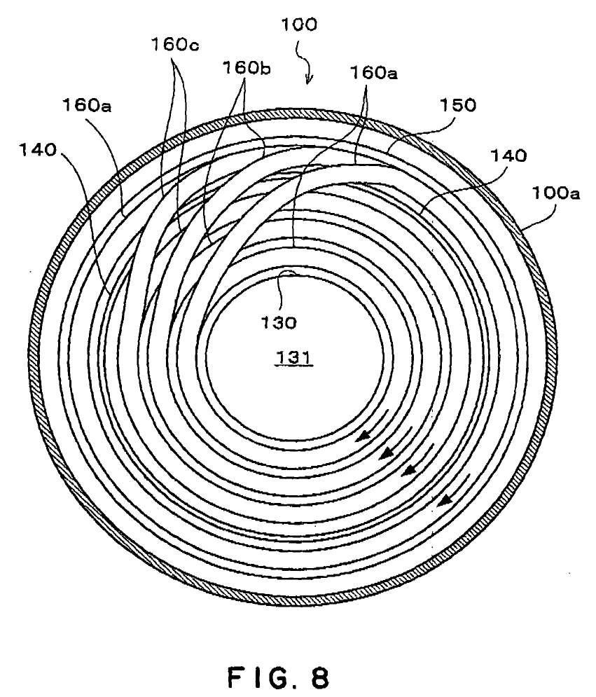

As shown in FIG. 4, the 3 pipes 160a, 160b, 160c are wound helically down to a lower part of the straightening vane 140 and then as shown in FIG. 5, curved upward from the inside of the straightening vane 140 along the outside circumferential surface of the straightening vane 140, bypassing the lower end of the straightening vane 140 as shown in FIG. 8. In the region S5, the 3 pipes 160a, 160b, 100c are arranged helically along the outside circumferential surface of the straightening vane 140.

The pipe 160a, which is positioned innermost in the region S6, is wound from the lowermost position among the pipes 160a, 160b, 160c in the region S5. The pipe 160b is wound upper of the pipe 160a and adjacently spaced from the pipe 160a at a set interval. The pipe 16c wound upper of the pipe 160b and adjacently spaced from the pipe 160b at a set interval. That is, the 3 pipes 160a, 160b, 160c are horizontally juxtaposed (juxtaposed with each other with their transverse sections arranged in a horizontal line) and formed helically. In the region 55, which is outer of the straightening vane 140, the 3 pipes 160a, 160b, 160c are vertically juxtaposed (juxtaposed with each other with their transverse sections arranged in a vertical line) and formed helically.

As shown in FIG. 5, in the region 55, the 3 pipes 160a, 160b, 160c are wound up to an upper part of the straightening vane 140 and then, near the underside of the baffleplate extended toward the underside of the baffleplate 150, curved upward toward the underside of the baffleplate 150. Further, as shown in FIG. 7, the pipes 160a, 160b, 160c are passed through the part of the baffleplate 150 which is outer of the straightening vane 140 and, as shown in FIG. 6, are respectively passed through the cap 100c of the chemical liquid tank 100.

In the region S6 numbers of winds of the pipes 160a, 160b, 160c are larger than in the region 35. A chemical liquid is heated in the region S6, decreasing the specific gravity and moves upward to smoothly flow toward the chemical liquid supply line (outlet pipe) 105, which is disposed upper in the region S6. That is, the chemical liquid is drawn at the top of the region S6 by the operation of the pump 112. Numbers of winds of the pipes 160a, 160b, 160c are made larger in the region S6 than in the region S5, whereby the flow of the chemical liquid can be made more efficient. Accordingly, the chemical liquid can be efficiently heated.

In the regions S5, S6, the 3 pipes 160a, 160b, 160c are held at a set interval by a digital support member not shown. The support member is fixed to the inside and the outside of the straightening vane 140. That is, the 3 pipes 160a, 160b, 160c are fixed to the straightening vane 140 via the support member. The support member is made of PFA.

The straightening vane 140, the baffleplate 150, the 3 pipes 160a, 160b, 160c and the support member are integrally supported by the inner cylinder 130. As described above the inner cylinder 130 is jointed to the cap 160c. When the chemical liquid tank 100 is assembled, the straightening vane 140, the baffleplate 150, the 3 pipes 160a, 160b, 160c and the support member are arranged around the inner cylinder 130 and then inserted into the cylindrical wall 100a integrally, and the opening in the top of the cylindrical wall 100a is closed by the cap 100c.

The pipes 160a, 160b, 160c are formed of PFA as described above. However, generally the pipes made of a chemical liquid resistant resin, such as PFA, have a restricted radius of curvature; when a pipe has circular section, the pipes cannot be curved at a radius of curvature which is below about 10 times a radius of the section. However, arranging the pipes 160a, 160b, 160c helically makes it possible to accommodate the pipes 160a, 160b, 160c, curved at an allowable radius of curvature which is above about 10 times a radius of the sectional area and in a sufficiently high density of winds of the pipes 160a, 160b, 160c. Accordingly, a surface area required for adjusting the temperature 6f a chemical liquid can be formed. The liquid contact surfaces of the pipes 160a, 160b, 160c, which contact a chemical liquid has chemical liquid resistance, and accordingly there is no risk of causing metal contamination which contaminates wafers W. Making the pipes of PEA can lower costs in comparison with making them of a metal, such as SUS steel or others and further making a surface treatment for suppressing the elation of the metal.

The 3 pipes 160a, 160b, 160c are branched pipes in which a main pipe 170 is branched and are joined again in the main pipe. A temperature adjusting means 173 for adjusting the temperature of a heat medium and a magnet pump 174 are inserted in the main pipe 170. A heat medium in the main pipe 170 is circulated between the chemical liquid tank 100 and the temperature adjusting means 173 by the operation of the magnet pump 174 inserted in the route where a chemical liquid flows from the temperature adjusting means 173 to the chemical liquid tank 100.

The temperature adjusting means 173 comprises a flange heater 181, a sheath heater 182 and a jacket 183 housing the sheath heater 182. A heat medium is heated by the sheath heater 182 in the jacket 183. A reserve tank 187 storing a heat medium is connected to the jacket 183 to supply the heat medium into the jacket 183. The reserve tank 187 has a relief valve 188. The use of the flange heater 181 and the sheath heater 182 lower the cost of a heat source for heating the heat medium.

In the present embodiment, the main pipe 170 which is arranged in the chemical liquid tank 100, branched in the pipes 160a, 160b, 160c, the temperature adjusting means 173 and the magnet pump 174 constitute a heat exchanger. Conventionally, a heat exchanger is disposed in the chemical liquid supply line 105, a pipe for passing a heat medium is disposed in the jacket of the heat exchanger, whereby a chemical liquid is stored in the jacket to have the temperature adjusted. In contrast to this, the chemical liquid tank 100 of the present invention, in which the pipes 160a, 160b, 160c for passing a heat medium are disposed, may allow the chemical liquid tank 100 and the heat exchanger to take smaller spaces in comparison with the conventional case, in which the pipes are disposed in the heat exchanger. Conventionally, when a chemical liquid in the chemical liquid circulatory supply circuit is replaced with the fresh chemical liquid, not only the chemical liquid stored in the chemical liquid tank 100 but also the chemical liquid in the jacket of the heat exchanger must be drained. In contrast to this, in the chemical liquid tank 100 of the present invention, only the chemical liquid tank 100 must be drained, and the amount of the drained chemical liquid can be small. Accordingly, the cost of the chemical liquid can be low.

In the jacket 183 of the temperature adjusting means shown in FIG. 3, a heat medium is heated to a required temperature by the sheath heater 182. The heated heat medium flows through the main pipe 170 and then is branched into the 3 pipes 160a, 160b, 160c. Then, the heat medium flows downward through the respective helical pipes 160a, 160b, 160c in the region S6. Then, the heat medium flows upward through the respective helical pipes 160a, 160b, 160c. When a prescribed amount of a heat medium is passed, a larger number of pipes more lowers the flow resistance of the heat medium in the pipes. The heat medium which has flowed through the respective 3 pipes 160a, 160b, 160c flows again into the main pipe 170, then joined together to be delivered to the heat adjusting means 173, and then flows again into the jacket 183 to be heated by the sheath heater 182.

On the other hand, the chemical liquid discharged from the inner chamber 6 to be recovered is led into the chemical liquid tank 100 through the chemical liquid recovery line (inlet pipe) 115 and into the upper region S4 upper of the baffleplate 150, bypasses the baffleplate 150, passing through the gap G1 and flows into the region S5 between the cylindrical wall 100a and the straightening vane 140. In the region 55, the chemical liquid descends in the region S5 along the outside of the straightening vane 140, passing around the 3 pipes 160a, 160b, 160c vertically arranged. Meanwhile the chemical liquid is heated by the heat medium by the heat conducted via the pipes 160a, 160b, 160c and has the temperature gradually increased. At the lower part in the region S5, the chemical liquid bypasses the lower end of the straightening vane 140, passes through the gap G2 to flow into the region S6 between the inner cylinder 130 and the straightening vane 140. In the region S6, the chemical liquid passes through the gaps defined between the respective 3 pipes 160, 160b, 160c, which are arranged side by side to ascend in the region S6 along the inside of the straightening vane 140 toward the underside of the baffleplate 150. Meanwhile the chemical liquid is heated by the heat of the heat medium conducted via the pipes 160a, 160b, 160c to have the temperature gradually increased. At an upper part in the region S6, the chemical liquid which has been heat exchanged is led out at below the baffleplate 150 through the chemical liquid supply line (outlet pipe) 105. As described above, in the chemical liquid tank 100, the baffleplate 150, the straightening vane 140, the chemical liquid supply line (outlet pipe) 105 lead a chemical liquid to form a flow passage of the chemical liquid, in which the chemical liquid flows sequentially in the region S4, the region S5 and the region S6.

As described above, a chemical liquid follows the flow passage in which the chemical liquid is introduced into the region S4, descends in the region S5, and then ascends in the region S6. In contrast to this, as described above, a heat medium follows the flow passage in which the heat medium descends through the respective pipes 160a, 160b, 160c in the region S6, ascends through the respective pipes 160a, 160b, 160c in the region S5. In other words, the heat medium and the chemical liquid oppositely flow.

The heated heat medium is deprived of the heat by the chemical liquid while descending in the region S6 and ascending in the region S5; the temperature is higher more upstream and goes on decrease toward the downstream. The chemical liquid, which follows the flow passage opposite to the heat medium, is heated by the heat medium of a lower temperature at the upstream and heated toward the downstream by the heat medium of higher temperatures. The heat exchange effectiveness can be higher.

The IPA recovery line 116 recovers the discharged IPA in an IPA tank not shown. The IPA tank has the same structure as the chemical liquid tank 100. The IPA recovery line 116, the IPA tank and the IPA supply line 108 constitute an IPA circulatory supply circuit.

Then, the processing by using the substrate processing system 1 having the above-described structure will be explained. First, outside the double chamber 8, 25 wafers W are loaded into the rotor 70 by a wafer load in/out mechanism not shown.

Subsequently, the rotor rotating mechanism 10 is moved into the substrate processing system 1 by the moving supporting mechanism and is supported with the disc 92 opposed to the rotor rotating mechanism entry/exit opening 17. Then, the rotor 70 mounting the wafers W is advanced horizontally into the double chamber 8 through the rotor rotating mechanism entry/exit opening 17. The double chamber 8 stands by with the inner chamber 6 located at the processing position in the outer chamber 5, with the rotor 70 located in the inner chamber 6 and with the cap 73 closing the rotor rotating mechanism entry/exit openings 17, 47. The tightly closed processing space S1 is thus formed.

Next, the rotor 70 starts to be rotated and is accelerated from the standstill state to a prescribed rotation number to rotate the wafers W integrally with the rotor 70. On the other hand, a chemical liquid having the temperature adjusted to a prescribed temperature in the chemical liquid tank 100 is injected from the processing fluid injection nozzle 43 to be applied to the wafers W on rotation. Contaminants, such as particles, organic contaminants, etc., staying on the wafers W are thus removed.

The chemical liquid fed to the wafers W is drained out of the inner chamber 6 through the drain pipe 44 and delivered to the chemical liquid recovery line 115 to be recovered in the chemical liquid tank 100. In the chemical liquid tank 100, the recovered chemical liquid has the temperature again adjusted to the prescribed temperature, for re-use, by the heat medium flowing through the pipes 1601, 160b, 160c.

After the chemical liquid processing is completed, the wafers Ware rotated at higher speed than in the chemical liquid processing to scatter off the chemical liquid staying on the wafers W by the centrifugal force. After the scattering processing, IPA is injected from the processing fluid injection nozzle 43 to be applied to the respective wafers W on rotation for rinse processing. For the rinse processing with IPA, the rotor 70 is rotated at a lower speed than in the scattering processing.

The IPA supplied to the wafers W is drained from the inner chamber 6 through the drain pipe 44 and is delivered to the IPA recovery line 116 to be recovered for re-use.

After the IPA processing, the inner chamber 6 is withdrawn out of the outer chamber 5 to the withdrawn position, and the tightly closed processing space 52 is established in the outer chamber 5. Then, pure water is injected from the processing fluid injection nozzle 13 to be applied to the respective wafers W for rinse. The pure water applied to the wafers W is drained out of the outer chamber 5 through the drain pipe 14.

After the rinse with the pure water, while the wafers W are being rotated at a higher speed, e.g., 800 rpm, than in the pure water processing, nitrogen gas is injected from the processing fluid injection nozzle 13 in the processing space S2 in the outer chamber 5 to be applied to the respective wafers W for drying. The nitrogen gas applied to the wafers W is exhausted out of the outer chamber 5. For the drying processing, in place of nitrogen gas, an inert gas, or IPA vapor or others which are volatile and hydrophilic may be applied to the wafers W.

After the drying processing completed, the injection of nitrogen gas is stopped, the rotation of the rotor 70 is stopped, and the rotor 70 is withdrawn out of the double chamber 8 horizontally through the rotor rotating mechanism entry/exit opening 17 by the moving supporting mechanism not shown. The 25 wafers are unloaded from the rotor 70 by a wafer loading in/out mechanism not shown outside the substrate processing system 1.

According to such substrate processing system 1 and such chemical liquid tank 100, arranging the pipes 160a, 160b, 160c for flowing a heat medium in the chemical liquid tank 100 allows the chemical liquid tank 100 and the heat exchanger to take small spaces than the conventional case, in which the pipes for flowing process liquid are arranged in the heat exchanger. For example, in replacing a chemical liquid in the chemical liquid circulatory supply circuit 98 with the fresh chemical liquid, the amount of the drained liquid is smaller in comparison with in the case that a chemical liquid remaining in the chemical liquid tank 100 and the heat exchanger is drained. The cost of the chemical liquid can be lowered. The flow of a heat medium through the pipes 160a, 160b, 160c is opposite to that of a chemical liquid in the chemical liquid tank 100, which permits the chemical liquid to be efficiently heated.

Furthermore, the pipes of PFA, whose radius of curvature is restricted, are arranged helical, whereby a surface area required for the temperature adjustment of a chemical liquid can be provided. The chemical liquid tank 100, and the pipes 160a, 160b, 160c, the straightening vane 140, the baffleplate 150, the support member, etc., which are arranged in the chemical liquid tank 100, are made of PEA, and accordingly the liquid contact surfaces to which a chemical liquid contacts in the chemical liquid tank 100 has chemical liquid resistance, whereby there is not risk of metal contamination which contaminates wafers W, and costs can be lower in comparison with the case in which a surface treatment for suppressing elution of metals to SUS steel, etc.

One of preferred embodiments of the present invention has been described above, but the present invention is not limited to the above-described embodiment. For example, the substrate processing system according to the present invention is not essentially for the cleaning processing and can be for processing other than the cleaning on substrates with other various processing liquids. The substrate processing system according to the present invention is not essentially of the type of the above-described embodiment and can be of various types, such as sheet type, batch type, spin type, etc. Substrates are not limited to semiconductor wafers and can be glass for LCD substrates, CD substrates, print substrates, ceramic substrates, etc. The present invention is not limited to substrate processing systems and is applicable to processing systems for various processing objects-to-be-processed other than substrates.

The processing liquid stored in the processing liquid tank is not limited to chemical liquids for use in the cleaning processing. Other various processing liquids can be stored and have the temperature adjusted. When the chemical liquid tank heats processing liquids of high flammability, means using electricity, such as the temperature adjusting means 173, the magnet pump 174, etc., can be positioned sufficiently remote from the tank advantageously in safety in comparison with the conventional case that a heater, etc. are provided on the outside of the wall of the processing liquid tank.

The chemical liquid tank 100, the straightening vane 140, the baffleplate 150, the pipes 160a, 160b, 160c, the support member are made of PEA but may be made of other chemical liquid resistance, such as fluorine plastics, etc. As long as their liquid contact surfaces are formed of a chemical liquid resistant resin, their liquid contact surfaces maybe coated with, e.g., chemical liquid resistant resins to be made chemical liquid resistant, and in this case as well, the processing liquid tank and the heat exchanger can take smaller spaces, and there is not risk of the metal contamination which contaminates wafers.

In the above-described embodiment, the chemical liquid tank 100 and the inner cylinder 130 are cylindrical, and the 3 pipes 160a, 160b, 160c are arranged helically. However, as long as a radius of curvature of the pipes 160a, 160b, 160c permits, the pipes 160a, 160b, 160c can be disposed in other arrangements in the chemical liquid tank 100. For example, the shapes of the chemical liquid tank 100 and the inner cylinder 130 car be elliptic cylinders and cones.

The number of the pipes arranged in the chemical liquid tank 100 can be 2 or less, or 4 or more as long as the flow resistance of the heat medium in the pipes can be low.

In the present embodiment, the pipes 160a, 160b, 160c are arranged helically in the region S5 outer of the straightening vane 140 and the region S6 inner of the bafflplate 140. However, the pipes 160a, 160b, 160c are not formed helically in the region S5 outer of the straightening vane 140 but formed helically only in the region S6 inner of the baffleplate 140, where the chemical liquid ascends. In this case as well, the pipes 160a, 160b, 160c are disposed in a region where the chemical liquid supply line (outlet pipe) 105 is disposed at an upper part, whereby the heated chemical liquid can ascend to be led to the chemical liquid supply line (outlet pipe) 105.

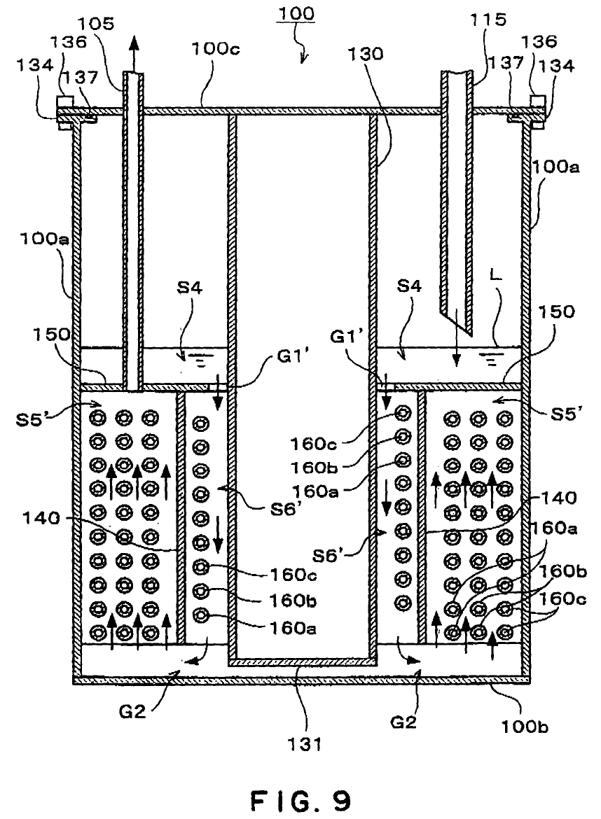

In the present embodiment, a chemical liquid descends along the outside of the straightening vane 140, passes between the lower part of the straightening vane 140 and the bottom surface of the chemical liquid tank 100, and then ascends along the inside of the straightening vane 140. That is, the flow passage of a chemical liquid having the outer part of the straightening vane 140 as the upstream and the inner part of the straightening vane 140 as the downstream has been explained. However, as shown in FIG. 9, the flow passage of a chemical liquid, in which a chemical liquid descends along the inside of the straightening vane 140 and then ascends along the outside of the straightening vane 140, i.e., the inner part of the straightening vane 140 is the upstream, and the outer part of the straightening vane 140 is the downstream may be formed. For example, the baffleplate 150 in an annular shape is fixed to the inside wall of the chemical liquid tank 100, i.e., the inside circumferential surface of the cylindrical wall 100a with a gap G1′ defined between the inner circumferential edge of the baffleplate 140 and the outside circumferential surface of the inner cylinder 130. The straightening vane 140 is fixed to the underside of the baffleplate 150. The region S4 upper of the baffleplate 150 and the region S6′ inner of the straightening vane 140 are in communication with the gap G1′, and the region S6′ inner of the straightening vane 140 and the region S5′ outer of the straightening vane 140 are in communication with the gap G2. The region S5′ outer of the straightening vane 140 is closed at the top by the baffleplate 150. The chemical liquid supply line (outlet pipe) 105 is opened in the underside of the baffleplate 150 to draw the chemical liquid near the underside of the baffleplate 150 out of the region S5′, which is outer of the straightening vane 140.

A chemical liquid is led into the chemical liquid tank 10 through the chemical liquid recovery line (inlet pipe) 115, bypasses the baffleplate 150 to pass through the gap G1′ and flows into the region S6′, descends in the region S6′, bypasses the underside of the straightening vane 140 to pass through the gap G2 and flows into the region S5′, ascends toward the underside of the baffleplate 150 in the region S5′, and is led out from below the baffleplate 150 at an upper part in the region S5′ through the chemical liquid supply line (outlet pipe) 105. The flow passage of a chemical liquid, which sequentially passes through the regions S4, S6′, S5′ in the chemical liquid tank 100 is thus formed.

In this case, in the region S6′, the 3 pipes 160a, 160b, 160c are vertically juxtaposed and formed helically, and in the region S5′, juxtaposed horizontally apart from the center and formed helically. That is, the numbers of winds of the respective pipes 160a, 160b, 100c are larger in the region S5′, where a chemical liquid ascends toward the chemical liquid supply line (outlet pipe) 105. A chemical liquid heated decreases the specific gravity and ascends, whereby the chemical liquid can be led to the chemical liquid supply line (outlet pipe) 105.

A heat medium first flows into the respective helical pipes 160a, 160b, 160c in the region S5′ and helically flows downward. Then, the heat medium helically flows upward through the respective helical pipes 160a, 160b, 160c. That is, the heat medium descends in the region S5′ through the respective pipes 16a, 160b, 160c, and then ascends in the region S6′ through the respective pipes 160a, 160b, 160c. In this case as well, the heat medium and the chemical liquid flow oppositely to each other, whereby the heat exchange effectiveness can be high.

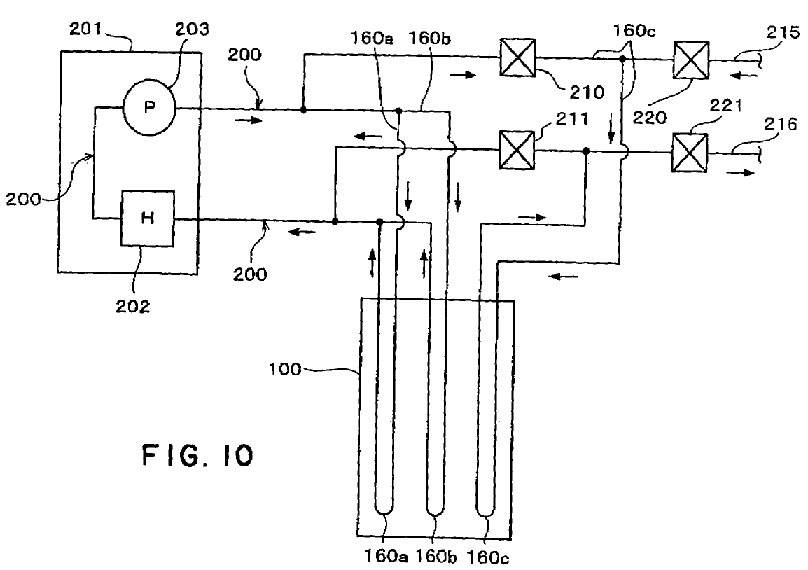

In the present embodiment, a heated heat medium, i.e., a heating heat medium is passed through the 3 pipes 160a, 160b, 160c. However, the state where a cooling heat medium is passed through the pipe 160c of the 3 pipes 160a, 160b, 160c and the state where a heating heat medium is passed through the pipe 160c may be changed over. As shown in FIG. 10, the 3 pipes 160a, 160b, 160c are branched pipes of a pipe 200. The pipe 200 is passed through a boiler 201. In the boiler 201, a heater 202 and a pump 203 are inserted in the pipe 200. A heat medium in the pipe 200 is circulated between the chemical liquid tank 100 and the heater 202 by the operation of the pump 203.

In the pipe 160c, opening/closing valves 210, 211 are inserted in the upstream thereof where a heat medium flows to the chemical liquid tank 100 and in the downstream thereof where the heat medium which has passed through the chemical liquid tank 100. A cooling water supply pipe 215 is connected to the pipe 160c between the part thereof passed through the chemical liquid tank 100 and the opening/closing valve 210. The pipe 160c is connected to a cooling water recovery pipe 216 between the part thereof passed through the chemical liquid tank 100 and the opening/closing valve 211. Opening/closing valves 220, 221 are inserted respectively in the cooling water supply pipe 215 and the cooling water recovery pipe 216.

With the opening/closing valves 210, 211 opened and the opening/closing valves 220 221 closed, a heat medium has the temperature adjusted by the heater 202, then flows through the pipe 200 and branched into the 3 pipes 160a, 160b, 160c to give the heat to a chemical liquid in the chemical liquid tank 100, then flows out of the 3 pipes 160a, 160b, 160c to join and flow through the pipe 200, and again has the temperature adjusted in the heater 202.

With the opening/closing valves 210, 211 closed and the opening/closing valves 220, 221 opened, cooling water as a cooling heat medium flows through the pipe 160c. That is, the heating heat medium having the temperature adjusted by the heater 202 flows through the pipe 200, is branched into 2 pipes 106a, 160b, gives the heat to the chemical liquid in the chemical liquid tank 100, flows out of the pipes 160a, 160b to join and flows into the pipe 200, and has the temperature again adjusted by the heater 202. The heating heat medium in the pipe 200 is circulated between the chemical liquid tank 100 and the heater 202 by the operation of the pump 203. On the other hand, the cooling water flows through the cooling water supply pipe 215, flows through the pipe 160c, gives the cooling heat to the chemical liquid in the chemical liquid tank 100, and flows through the cooling water recovery pipe 216 to be recovered.

For example, when a chemical liquid is heated, a heating heat medium is passed through the respective 3 pipes 160a, 160b, 160c. When the chemical liquid is adjusted to a temperature near the room temperature (e.g., below 40° C.), the heating heat medium is passed through the 2 pipes 160a, 160b, and the cooling water is passed through the pipe 160c. The pipes 160a, 160b as well may be arranged to pass the cooling water for the purpose of draining a heated chemical liquid, cooled.

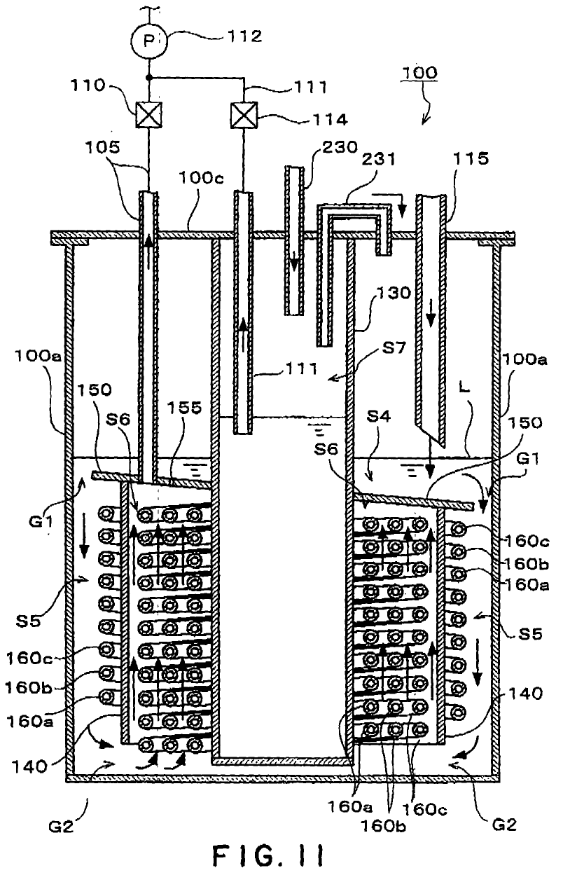

The chemical liquid tank 100 may have the structure as shown in FIG. 11, which stores, e.g., a, not used, fresh chemical liquid in an interior space S7 inside the inner cylinder 130. In this case, the heat of a chemical liquid outside can be conducted to the fresh chemical liquid inside the inner cylinder 130 to thereby keep the temperature of the latter near a temperature of the former, whereby when the fresh chemical liquid is supplied to the outside of the inner cylinder 130, the chemical liquid outside the inner cylinder 130 can be adjusted to a prescribed temperature.

As exemplified in FIG. 11, a fresh chemical liquid supply line 111 connected to the chemical liquid supply line 105 and a fresh chemical liquid introduction line 230 for leading the fresh chemical liquid in the inner cylinder 130 are passed through the cap 160c. An overflow line 231 interconnecting the inner space 57 and the space outer of the inner cylinder 130 is provided to thereby the fresh chemical liquid overflowing the inner space S7 is led into between the inner cylinder 130 and the cylindrical wall 100a. The overflow line 231 is opened nearer the liquid surface than the fresh chemical liquid supply line 111. The temperature of the fresh chemical liquid is adjusted by the pipes 160a, 160b, 160c disposed outside of the inner cylinder 130. The thus connection of the fresh chemical liquid supply line 111 to the inner space S7 of the inner cylinder 130 makes it unnecessary to provide the extra fresh chemical liquid tank 113 described above, and the space can be further saved. The fresh chemical liquid can have the temperature adjusted by the pipes 160a, 160b, 160c disposed outside the inner cylinder 130, which makes it unnecessary to provide the above-described temperature adjusting means provided in the fresh chemical liquid tank 113, which further lowers costs.

As shown in FIG. 11, it is possible that the baffleplate 150 is tilted so that the chemical liquid supply line 105 and the air vent hole 155 can be opened upper of the baffleplate 150. In this case, the stagnation of air bubbles below the baffleplate 150 can be effectively prevented. When the chemical liquid is drained at a lower part of the chemical liquid tank 100, the tiled top surface of the baffleplate 150 facilitates the drop of the chemical liquid, whereby the chemical liquid is prevented from remaining upper of the baffleplate 150.

In the processing liquid tank and the processing system according to the present invention, the pipes passing a heat medium are disposed in the processing liquid tank, whereby spaces required for the processing liquid tank and the processing system can be smaller. When a processing liquid in the supply line for the processing liquid is replaced with the fresh processing liquid, the mount of the waste liquid can be small, which can decrease the costs of the processing liquid. The flow of a heat medium passing through the pipes and the flow of a processing liquid in the processing liquid tank are opposite to each other, which permits the processing liquid to be heated efficiently. The pipes whose radius of curvature is restricted are arranged helically, which can provide a surface area required for the temperature adjustment of a processing liquid. The liquid contact surface inside the processing liquid tank has chemical liquid resistance, whereby there is no risk of metal contamination which contaminates wafers, and costs can be lower in comparison with the case that a surface treatment for suppressing the metal elution is made on SUS steel, etc.

What is claimed is

1. A processing liquid tank for storing a processing liquid comprising:
an inner cylinder disposed in the processing tank;
the processing liquid being stored outside of the inner cylinder,
a pipe for flowing a heat medium disposed in the processing liquid.

2. The processing liquid tank according to claim 1, comprising:
a cylindrical straightening vane,
a flow passage of the processing liquid where the processing liquid descends along the inside of the cylindrical straightening vane, passes between a lower part of the straightening vane and the bottom surface of the processing liquid tank and then ascends along the outside of the straightening vane, or a flow passage of the processing liquid where the processing liquid descends along the outside of the straightening vane, passes between a lower part of the straightening vane and the bottom surface of the processing liquid tank and ascends along the inside of the straightening vane being formed, and
the pipe being arranged in the flow passage.

3. The processing liquid tank according to claim 2, wherein
the flow of the heat medium passing through the pipe and the flow of the processing liquid are opposite to each other.

4. The processing liquid tank according to claim 2, which comprises
a baffleplate for partitioning the interior of the processing tank in an upper part and a lower part, the baffle plate being positioned upper of the pipe and the straightening vane; and
an outlet pipe for drawing the processing liquid below the baffleplate out of a region inner or outer of the straightening vane without mixing the processing liquid below the baffle plate with the processing liquid upper of the baffle plate.

5. The processing liquid tank according to claim 4, wherein
the baffleplate is fixed to the inner cylinder or to the inside wall of the processing liquid tank, and
the straightening vane is fixed to the baffleplate.

6. The processing liquid tank according to claim 4, wherein
the baffleplate is tilted, and
the outlet pipe is disposed in the higher part of the baffleplate.

7. The processing liquid tank according to claim 2, wherein
the pipe being formed helically in the region outer of the straightening vane.

8. The processing liquid tank according to claim 2, wherein
the pipe is formed helically in the region inner of the straightening vane.

9. The processing liquid tank according to claim 2, wherein
the pipe is formed helically in the region outer of the straightening vane and in the region inner of the straightening vane.

10. The processing liquid tank according to claim 1, comprising
a plurality of the pipes, the pipes being arranged substantially in parallel with each other.

11. The processing liquid tank according to claim 7, comprising:
a plurality of the pipes,
the pipes being juxtaposed with each other with their transverse sections arranged in a vertical line and formed helically in the region outer of the straightening vane.

12. The processing liquid tank according to claim 8, comprising:
a plurality of the pipes,
the pipes being juxtaposed with each other with their transverse sections arranged in a horizontal line and formed helically in the region inner of the straightening vane.

13. The processing liquid tank according to claim 9, comprising:
a plurality of the pipes,
the pipes being juxtaposed with each other with their transverse sections arranged in a vertical line and formed helically in the region outer of the straightening vane and being juxtaposed with each other with their transverse sections arranged in a horizontal line and formed helically in the region inner of the straightening vane.

14. The processing liquid tank according to claim 10, wherein
at least one of said plural pipes can be changed over to pass a cooling heat medium and to pass the heating heat medium.

15. The processing liquid tank according to claim 1, wherein
the liquid contact surfaces of the processing liquid tank and the pipe are respectively made of a chemical liquid resistant resin.

16. The processing liquid tank according to claim 1, wherein
the inner cylinder has the bottom closed capably of storing a liquid inside.

17. The processing liquid tank according to claim 16, wherein
the liquid in the inner cylinder has a temperature adjusted by the heat medium or the processing liquid.

18. A processing system comprising:
the processing liquid tank according to claim 1;
a processing unit for processing objects-to-be-processed; and
a processing liquid supply line for supplying a processing liquid from the processing liquid tank to the processing unit.
